(19) United States
(12) Patent Application Publication
(10) Pub. No.: US 2011/0315725 A1
(43) Pub. Date: Dec. 29, 2011

(54) LOAD COMPARTMENT

(76) Inventor: Rubens F. Soldatelli, Caxias do Sul (BR)

(21) Appl. No.: 13/094,283

(22) Filed: Apr. 26, 2011

(30) Foreign Application Priority Data
Apr. 26, 2010 (BR) PI1001119-6

(51) Int. Cl. B60R 5/00

(52) U.S. Cl. 224/42.32

(57) ABSTRACT

A load compartment comprises a set consisting of a first compartment having a frame, a cover, a frontal part, lateral supports of rigid materials, and a second compartment of flexible material inside of it. The cover and the frontal part are connected to the frame by means of joints. This set is used in open and/or closed positions and may be arranged in different parts of a vehicle bed.

### CROSS-REFERENCE TO RELATED APPLICATION

This application claims the benefit of Brazilian Patent Application Serial No. PI100119-6, filed on Apr. 26, 2010, the contents of which are herein incorporated by reference in their entirety.

### FIELD OF THE INVENTION

The present invention relates to load compartments, and more particularly, to cargo boxes for pickup trucks.

### BACKGROUND OF THE INVENTION

It is known to place cargo boxes in pickup truck beds for more versatile and secure storage of tools and other small items. However, further improvements are possible.

### SUMMARY OF THE PRESENT INVENTION

In view of the foregoing, it is an object of the present invention to provide an improved load compartment. The load compartment may be manufactured in varied sizes and shapes, by using metal, plastic, wood and/or any other synthetic and/or natural material suitable for the desired end, to be preferably used on vehicle beds.

The load compartment can be used at any other place or system as well as contain the most varied kinds of materials, either jointly or separately, such as metal, wood, plastic and/or the like, rigid and/or flexible materials and/or the like without changing its nature since the characteristics initially claimed herein are not lost.

The load compartment is developed and designed from a set comprising a set of parts that make up a rigid box with an internal part of flexible material, vinyl and/or the like; the rigid part ensures the safety of a rigid load compartment and the internal part of flexible material ensures perfect sealing, protecting it from dust and water; the parts that make up the box, the internal part, and other components of the set may be made of different kinds of materials and have different finishes.

The subject matter hereof may contain other devices added to its functionality without changing its nature since the characteristics initially claimed herein are not lost.

There are no similar products in the prior art devices of this nature.

The load compartment will be described in a clear, concise, and objective manner on the basis of a set of illustrative drawings related to the model proposed herein so that anyone skilled in the art can clearly understand and put it into practice. It is presented for demonstration purposes only without intending to limit it by the scope of patent protection and serves for a more detailed analysis of the characteristics to be claimed herein.

Nevertheless, this model is not limited to the form presented herein and other configuration concepts may be considered since they keep the same distinctive functional characteristics of the base model.

### BRIEF DESCRIPTION OF THE DRAWINGS

FIG. 1 is a perspective view of a load compartment, according to an embodiment of the present invention, including a frame, door, frontal part, and compartment;

FIG. 2 is a perspective view of the load compartment of FIG. 1, in a partially closed position;

FIG. 3 is a perspective view of the load compartment of FIG. 1, in an open position placed in a frontal part of a vehicle bed;

FIG. 4 is a perspective view of the load compartment of FIG. 1, in a closed position placed vertically in the frontal part of the vehicle bed;

FIG. 5 is a perspective view of the load compartment of FIG. 1, in a closed position placed horizontally in the frontal part of vehicle the bed;

FIG. 6 is a perspective view of the load compartment of FIG. 1, in a closed position, attached to a door of the vehicle bed;

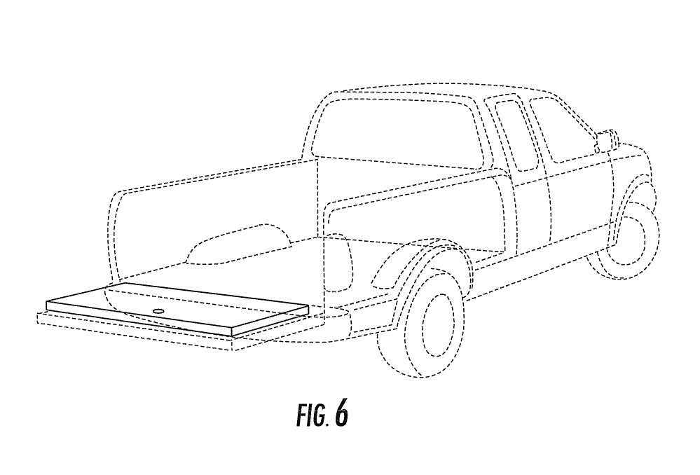

FIG. 7 is a perspective view of the load compartment of FIG. 1, in a closed position, placed horizontally in a rear part of the vehicle bed; and

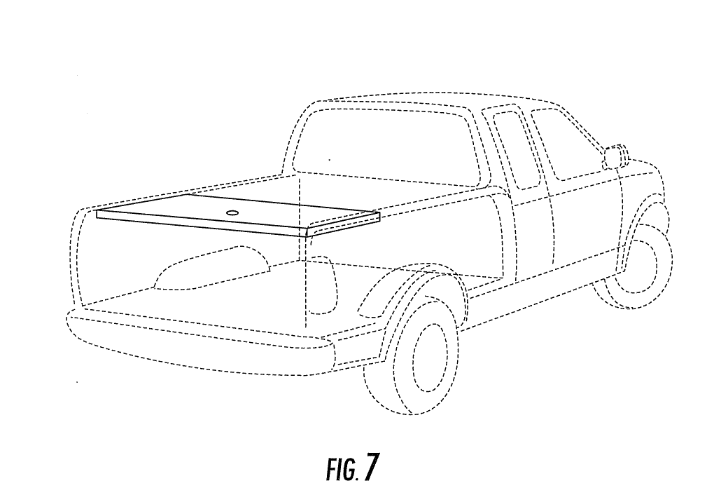

FIG. 8 is a perspective view of the load compartment of FIG. 1, in an open position placed in the rear part of the vehicle bed.

### DETAILED DESCRIPTION OF THE PREFERRED EMBODIMENTS

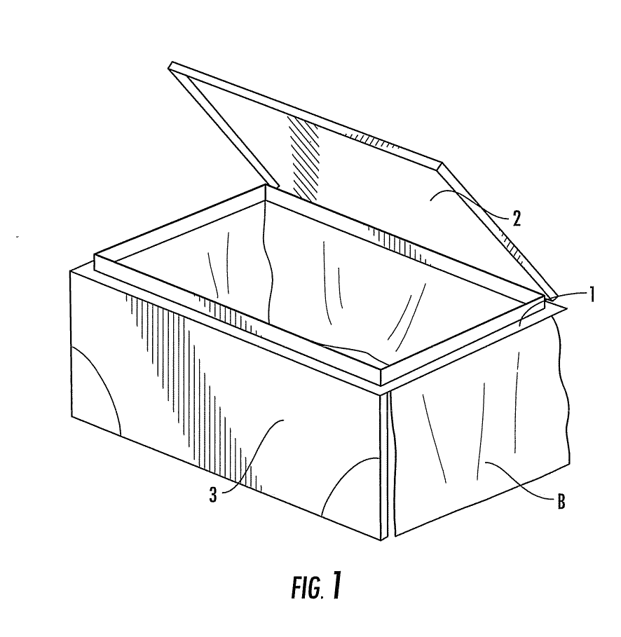

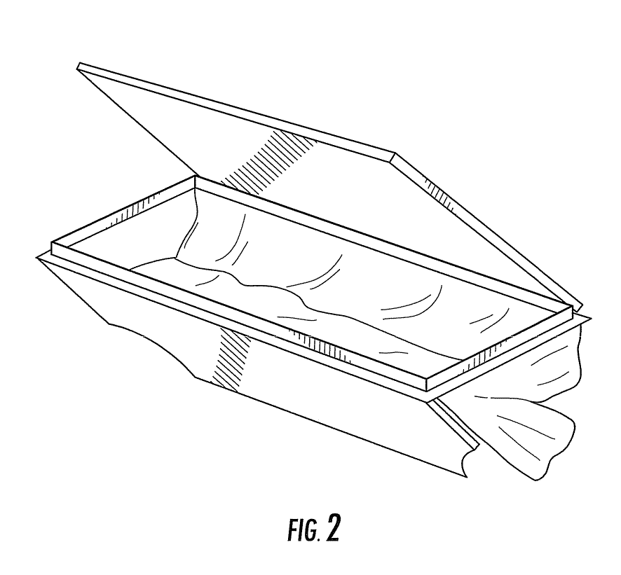

Referring to FIGS. 1 and 2, according to an embodiment of the present invention, a load compartment comprises a set consisting of a compartment A having a frame 1, a cover 2, a frontal part 3, lateral supports 4 of rigid material, and a compartment B of flexible material being inside of it. The cover 2 and the frontal part 3 are connected to the frame 1 by means of joints; this set is used in an open or closed position; the set is coupled to the supports 4 that attach it to the vehicle bed and have joints, fittings and/or the like to provide the set with better positioning and/or sealing.

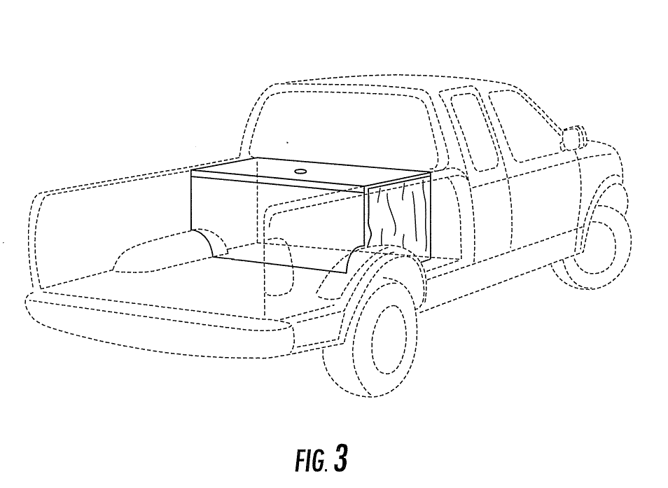

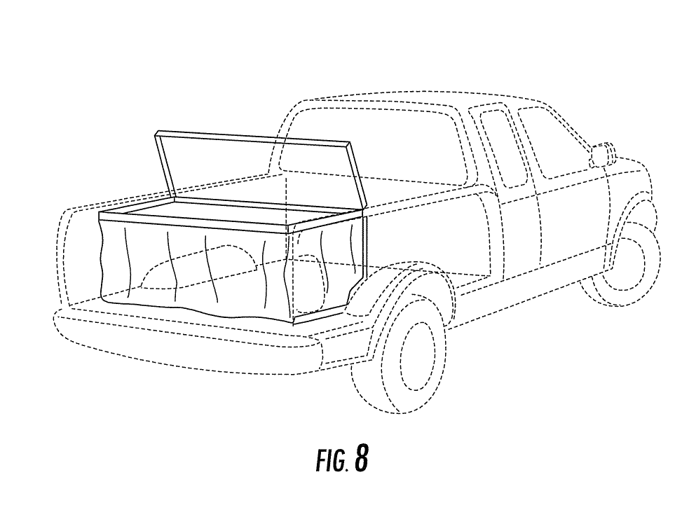

When it is open, the compartment A forms a kind of a box inside of which there is a compartment B of flexible material attached to the frame 1 in the same shape as the compartment A. The open set forms the compartment A with access through the cover 2 with or without a key; this set is protected because the cover 2 and frontal part 3 plus the internal parts of the vehicle bed turn this set into a closed box (see FIGS. 3 and 8); the compartment B made of vinyl, canvas and/or the like is in the internal part and ensures perfect sealing thus protecting itself from dust and water.

When the compartment A is closed, the frontal part rotates and becomes parallel to the frame while the compartment B is lodged, folded between the cover 2 and the frontal part 3. The frame 1, the cover 2, the frontal part 3, and the supports 4 have hinges, bolts, joints and/or the like with connections among themselves so that the set can be opened and/or closed. The compartment B may contain an additional cover of rigid and/or flexible material and have inflatable parts and/or be entirely inflatable itself for better sealing and thermal protection, and may be used outside the compartment A.

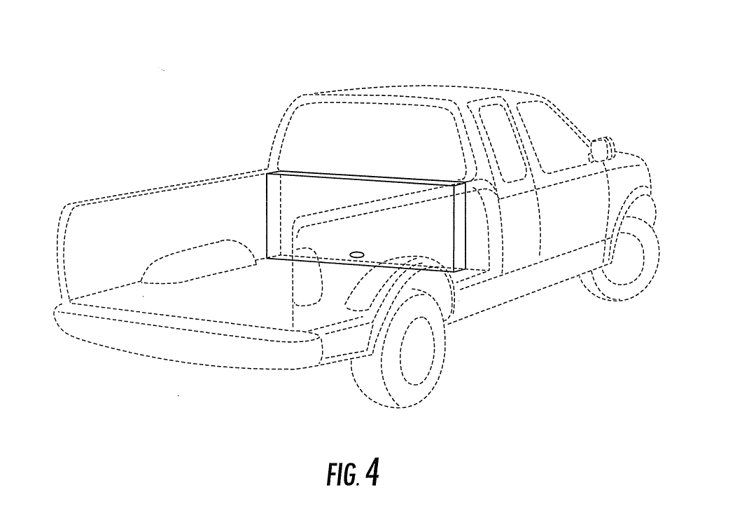

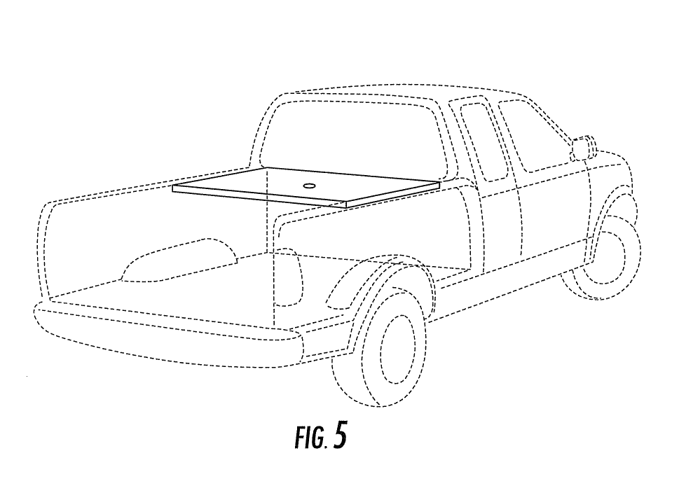

The set may be placed horizontally in a closed position in the frontal or rear part of the vehicle bed next to the cover of the vehicle bed (see FIG. 5), vertically next to the internal frontal part of the vehicle bed (see FIG. 4) and attached next to the internal part of the cover of the vehicle bed. The set may be used on the laterals of the bed, which is why there are laterals, either foldable or not, of rigid material which ensure that it is closed.

In general, the foregoing description is provided for exemplary and illustrative purposes; the present invention is not necessarily limited thereto. For instance, certain aspects of the model presented herein may be changed such as materials, shape, finishes, configurations, etc. without changing what has been initially claimed herein. Rather, those skilled in the art will appreciate that these and additional modifications, as well as adaptations for particular circumstances, will fall within the scope of the invention as herein shown and described and the claims appended hereto.

What is claimed is:

1. A load compartment comprising:
a first compartment A including a frame, a cover, a frontal part of rigid material, and a second compartment of flexible material, positioned inside the first compartment;
the cover, the frontal part, and the second compartment being attached to the frame.

2. A load compartment comprising:
a first compartment including a frame, a cover, a frontal part of rigid material, and a second compartment of flexible material, attached to the frame and positioned inside the first compartment;
the cover and the frontal part being attached to the frame, both of them having joints;
the first compartment being closable and foldable, the frontal part becoming parallel to the frame and the door with the second compartment lodged between the door and the frontal part.

3. A load compartment comprising:
a first compartment including a frame, a cover, a frontal part of rigid material, and a second compartment of flexible material positioned inside the first compartment;
the cover and the frontal part being attached to the frame, both of them having joints;
the first compartment being closable and foldable, the frontal part folding and becoming parallel to the frame and the door with the second compartment lodged between the door and the frontal part;
the second compartment having another cover and inflatable parts and/or being entirely inflatable.

4. The load compartment of claim 1, wherein the load compartment is configurable for use in an open position in a frontal part of a vehicle bed.

5. The load compartment of claim 1, wherein the load compartment is configurable for use in an open position in a rear part of a vehicle bed.

6. The load compartment of claim 1, wherein the load compartment is configurable for use in a closed position and placed vertically next to the internal frontal part of the vehicle bed.

7. The load compartment of claim 1, wherein the load compartment is configurable for use in a closed position and placed horizontally next to an internal frontal part of the vehicle bed, becoming level with lateral edges of the vehicle bed.

8. The load compartment of claim 2, wherein the load compartment is configurable for use in a closed position and placed next to an internal part of a cover of a vehicle bed.

9. The load compartment of claim 2, wherein the load compartment is configurable for use in a closed position and placed horizontally next to an internal rear part of the vehicle bed, becoming level with lateral edges of the bed.

10. The load compartment of claim 1, wherein the frontal part is cut out to conform with an internal part of a vehicle bed.

11. The load compartment of claim 1, further comprising attaching supports coupled to the frame, frontal part and/or the like.

12. The load compartment of claim 11, wherein the supports include parts for sealing of the load compartment when it is open.

13. The load compartment of claim 11, wherein the attaching supports are inserted in the frame.

14. The load compartment of claim 2, wherein, when the load compartment is closed and/or open, the load compartment contains joints, bolts, fasteners, or hinges and/or the like for fitting in the desired positions.

15. The load compartment of claim 1, wherein the second compartment is attached to the frame by means of Velcro, a fastener, fittings, supports and/or the like.

16. The load compartment of claim 1, wherein the second compartment is made of a flexible material such as canvass, vinyl, plastic and/or the like.

17. The load compartment of claim 2, wherein the second compartment has a configuration, hinges, elastics, supports and/or the like so that it is easily folded.

18. The load compartment of claim 1, wherein the first compartment has other joined, foldable rigid parts and/or the like to complement the closure.

19. The load compartment of claim 1, wherein the door has cutouts and/or the like with configurations and/or the like in accordance with the internal shape of the vehicle bed.

20. The load compartment of claim 1, wherein the frontal part has cutouts and/or the like with configurations and/or the like in accordance with the internal shape of the vehicle bed.

21. The load compartment of claim 20, wherein the frontal part has additional parts and/or the like, either foldable or not, in the cut-outs.

22. The load compartment of claim 1, wherein, when the load compartment is open, the set has attaching supports, brackets, fittings and/or the like.

23. The load compartment of claim 1, wherein the first compartment is usable without the second compartment.

24. The load compartment of claim 1, wherein the second compartment has inflatable parts and/or the like or is entirely inflatable

25. The load compartment of claim 3, wherein the second compartment has an additional cover of rigid and/or flexible material and is usable outside the first compartment.

26. The load compartment of claim 1, wherein the second compartment has supports, rigid, flexible parts and/or the like.

27. The load compartment of claim 1, wherein the second compartment has internal partitions.

28. The load compartment of claim 1, wherein the first compartment has additional rigid parts.

29. The load compartment of claim 1, wherein, when it is closed, the first compartment is configured to be attached in an internal part of a cover of a vehicle bed.

30. The load compartment of FIG. 1, wherein the door is openable in different directions.

31. The load compartment of claim 1, wherein the door is openable in an opposite direction when the load compartment is used in a rear part of a vehicle bed.

32. The load compartment of claim 1, wherein the cover may have two or more parts and open in all directions, independently of each other, and attached differently from each other.

33. The load compartment of claim 1, wherein when the load compartment is used in a rear part of a vehicle bed, the load compartment is configurable to lock a cover of the vehicle bed, the cover of the vehicle bed being released after opening the cover of the first compartment.

34. The load compartment of claim 1, wherein, when the set is used in a rear part of a vehicle bed with marine canvas, a rear hem of marine canvas is open in an external part by a lock, fastener, latch and/or the like.

35. The load compartment of claim 34, wherein the rear hem of marine canvas is open in the external and/or an internal part by a lock, fastener, latch and/or the like.

36. The load compartment of claim 1, wherein, when the load compartment is used in a rear part of a vehicle bed, it may lock a cover of the vehicle bed.

37. The load compartment of claim 2, wherein, when the load compartment is closed, the frontal part may shift to another position without folding.

38. The load compartment of claim 1, wherein the load compartment is configured to be used in an open and/or closed position in any part of a vehicle bed.

39. The load compartment of claim 1, wherein the frame and the door contain adjustable parts and/or the like, for changing the size, configuration and/or the like of the load compartment.

40. The load compartment of claim 1, wherein the frame, the frontal part, and the door contain fake, addable parts and/or the like, for changing the size, configuration and/or the like of the load compartment.

41. The load compartment of claim 2, wherein the load compartment is openable and closeable automatically by means of motors, actuators, cylinders, spools, belts and/or the like.

42. The load compartment of claim 41, wherein the load compartment is openable and/or closeable automatically by means of a remote control.
